(19) United States
(12) Patent Application Publication
(10) Pub. No.: US 2007/0137169 A1
(43) Pub. Date: Jun. 21, 2007

(54) Integrated coal gasification combined cycle plant

(75) Inventors: Shigeyasu Ishigami, Nagasaki (JP); Yuichiro Kitagawa, Nagasaki (JP); Katsuya Ito, Nagasaki (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: MITSUBISHI HEAVY INDUSTRIES, LTD., Tokyo (JP)

(21) Appl. No.: 11/705,445

(22) Filed: Feb. 13, 2007

(30) Foreign Application Priority Data
Aug. 24, 2004 (JP) 2004-243715

(51) Int. Cl. F02C 3/28

(52) U.S. Cl. 60/39.12; 60/39.182

(57) ABSTRACT

A highly efficient integrated coal gasification combined cycle plant is provided having a dust removing system which can reliably exhibit a desired dust removing performance and which can maintain high operational reliability such that the occurrence of dust leaks is prevented. The integrated coal gasification combined cycle plant has a coal gasification furnace configured to yield a coal gas by gasification of coal, a gas turbine generator driven with a gas turbine which is operated using the coal gas as fuel and which discharges a high-temperature combustion exhaust gas, an exhaust heat recovery boiler configured to recover heat from the high-temperature combustion exhaust gas and to produce steam, and a steam turbine generator driven with a steam turbine operated using the steam produced by the exhaust heat recovery boiler. In the above plant, a flue gas desulfurization device configured to desulfurize the coal gas is provided downstream of the gas turbine and the exhaust heat recovery boiler, and the dust removing system which is configured to recover char and to remove dust from the coal gas has at least one line containing a cyclone, a front-stage filter, and a rear-stage filter.

### BACKGROUND OF THE INVENTION

1. Field of the Invention

The present invention relates to an integrated coal gasification combined cycle plant having a gas turbine generator operated using a coal gas as fuel which is obtained by gasification of coal, and having a steam turbine generator operated using steam obtained by recovering exhaust heat from a gas turbine, and in particular, the present invention relates to an integrated coal gasification combined cycle plant having a dust removing system which can realize increase in capacity of the integrated coal gasification combined cycle while simultaneously realizing higher efficiency and excellent environmental compatibility.

This application is based on Japanese Patent Application No. 2004-243715, the content of which is incorporated herein by reference.

2. Description of Related Art

Heretofore, in order to improve power generation efficiency of coal-fired power plants, integrated coal gasification combined cycle (hereinafter referred to as “IGCC”) plants have been developed and operated. This IGCC plant includes a gas turbine generator which is operated for power generation using a coal gas as fuel obtained by gasification of coal, and a steam turbine generator which is operated for power generation using steam obtained by recovering exhaust heat from a high-temperature combustion exhaust gas discharged from a gas turbine using an exhaust heat recovery boiler.

In the IGCC plant described above, in order to recover char and to remove sulfur components, which are contained in a coal gas generated in a coal gasification furnace, for environmental protection and the like, a dust removing system and a gas purification device are provided upstream of the gas turbine generator. In a dust removing system of the related art, one dust removing filtration device (filter) is provided at one stage; hence, when a dust leak occurs due to malfunction of the dust removing filtration device, char is dispersed and is carried into the gas purification device and the gas turbine, which are provided at the downstream side, thereby causing degradation in performance of the gas purification device and abrasion of gas turbine blades. In addition, since the emission amount of ash dust and that of sulfur components are increased at an outlet of a chimney which is configured to emit a combustion exhaust gas into the atmosphere, it becomes difficult to continuously operate the IGCC plant, and hence there has been a problem in that reliability of operation is inferior.

In addition, as a technique relating to the dust removing system, a dust removing system installed downstream of a combustion system which generates dust, such as a pressurized-fluidized bed boiler, has been proposed in which at least two lines, each containing a centrifugal dust removing device (cyclone) and a dust removing filtration device (filter) connected thereto in series, are disposed, and in which an equalizer pipe is provided so as to communicate between outlet-side gas pipes of the centrifugal dust removing devices. In this case, since only one dust removing filtration device is provided at one stage for each line, when a dust leak occurs, dust and the like are dispersed, and hence, in addition to abrasion of gas turbine blades, the amount of ash dust is increased at an outlet of a chimney. Accordingly, it is difficult to continue the operation of the IGCC plant, and as a result, the reliability in operation is inferior (for example, see Japanese Patent No. 3477346).

In addition, a two-stage dust removing system has also been disclosed in which in order to remove harmful gases contained in an exhaust gas by forming solid compounds, a device supplying a powdered alkaline agent is provided for an exhaust gas line communicating between a front-stage filtration chamber and a rear-stage filtration chamber (for example, see Japanese Patent No. 3262720).

In recent years, concomitant with the trend toward the increase in capacity and operation temperature of gas turbines, IGCC plants having larger capacity and higher efficiency have also been desired. In IGCC plants in which large volumes of coal gas are generated in coal gasification furnaces, the sizes of pipes for produced gas, cyclones, filters and the like are also inevitably increased, and as a result, problems in terms of functions of individual devices and costs thereof arise.

Accordingly, in order to solve the above problems, it has been conceived that a plurality of lines containing cyclones and filters may be provided in the dust removing system. However, in a dust removing system in which multiple lines are provided, since the pressure losses between the lines become different from each other depending on the amount of coal gas and the adhesion state of char, the gas amounts flowing through the lines also become unbalanced; hence, as a result, a problem in that desired dust removing performance cannot be obtained for the overall system may arise.

In addition, although the dust removing system is formed of a plurality of lines, if a dust leak occurs due to, for example, breakage of one filter in only one line among the plurality of lines, the gas turbine and the like provided downstream of the dust removing system are adversely affected, and it is difficult to continue the operation of the IGCC plant; hence, a problem of inferior reliability cannot be overcome.

Furthermore, since the gas purification device disposed downstream of the dust removing system causes a large pressure loss because of its desulfurization operation at a high pressure, the operation pressure of the gasification furnace must be maintained at a high level, and hence the power supplied to an air-pressure increasing device and to an oxygen/nitrogen compressor, both of which supply gases to the gasification furnace, is large, resulting in degradation in plant efficiency.

That is, it can be said that a dust removing system and a gas purification device, which can meet the requirements for recent IGCC plants aiming to realize larger capacity and higher efficiency, has not yet been actually realized. Accordingly, development of an integrated coal gasification combined cycle (IGCC) plant has been desired in which a dust removing system is provided having a desired dust removing performance even when the gas amount is increased concomitant with the increase in capacity and having a high operation reliability such that the occurrence of dust leaks is prevented, and in which, as a plant, a high efficiency can be achieved by low power consumption in the plant.

### BRIEF SUMMARY OF THE INVENTION

The present invention has been conceived in consideration of the above circumstances, and an object of the present invention is to provide an integrated coal gasification combined cycle plant in which a dust removing system is provided having a desired reliable dust removing performance and having a high operation reliability such that the occurrence of dust leaks is prevented, and in which a high efficiency can be achieved by low power consumption in the plant.

To this end, the present invention was made as follows.

An integrated coal gasification combined cycle plant of the present invention includes: a coal gasification furnace configured to yield a coal gas by gasification of coal, a gas turbine generator driven with a gas turbine which is operated using the coal gas as fuel and which discharges a high-temperature combustion exhaust gas, an exhaust heat recovery boiler configured to recover heat from the high-temperature combustion exhaust gas and to produce steam, a steam turbine generator driven with a steam turbine which is operated using the steam produced by the exhaust heat recovery boiler, a gas purification device configured to desulfurize the coal gas, provided downstream of the gas turbine and the exhaust heat recovery boiler, and a dust removing system configured to recover char and remove dust from the coal gas, which includes at least one line containing a cyclone and filters provided at multiple stages.

According to the integrated coal gasification combined cycle plant as described above, since the gas purification device configured to desulfurize the coal gas is disposed downstream of the gas turbine and the exhaust heat recovery boiler, and the dust removing system configured to recover char and remove dust from the coal gas is formed of at least one line containing a cyclone and filters provided at multiple stages, the coal gas supplied to the gas turbine may not pass through the gas purification device, and the pressure loss that occurs when the coal gas is made to pass through the gas purification device can be prevented. In addition, in the dust removing system having at least one line containing a cyclone and filters provided at multiple stages, since char and dust having a relatively large particle size can be recovered and removed by the cyclone, and char and dust having a relatively small size can be reliably recovered and removed by the filters provided at multiple stages, dust leaks toward devices, such as the gas turbine, located at the downstream side, can be prevented.

In the integrated coal gasification combined cycle plant described above, the dust removing system described above preferably includes a plurality of lines disposed in parallel to form a multiple-line configuration and may further include at least one equalizer pipe configured to connect between the lines of the dust removing system at inlets of the filters; hence, the occurrence of imbalances in gas flow rates between the lines can be prevented.

In the integrated coal gasification combined cycle plant described above, the filters provided at multiple stages are preferably the same. In the case described above, when the capacity of each filter is set to be not less than 100% of the capacity required for each line, even though one of the above filters provided at multiple stages has a problem and cannot be used, an IGCC plant having sufficient dust removing capacity can be continuously operated.

In the integrated coal gasification combined cycle plant described above, the char recovered by the dust removing system is preferably resupplied to the gasification furnace, and by this configuration, the operation efficiency of the plant is improved because of the increase in the amount of the coal gas obtained from coal.

In the integrated coal gasification combined cycle plant described above, the gas purification device provided downstream of the gas turbine and the exhaust heat recovery boiler is preferably a limestone/gypsum desulfurization device in which SOx is absorbed or an ACF desulfurization device using activated-carbon fibers.

According to the integrated coal gasification combined cycle plant of the present invention, since the coal gas to be supplied to the gas turbine may not pass through the gas purification device, the pressure of the coal gasification furnace can be decreased corresponding to the pressure loss generated when the coal gas is made to pass through the gas purification device. Hence, the power supplied to an air-pressure increasing device, an oxygen/nitrogen compressor, and the like, which supply gases to the gasification furnace, can be decreased, and as a result, the plant efficiency can be significantly improved.

In addition, by the use of the dust removing system which includes at least one line containing the cyclone and the filters provided at multiple stages, after char, dust, and the like having a relatively large particle size are recovered and removed by the cyclone, remaining char, dust and the like of relatively small size are sequentially recovered and removed by the filters provided at multiple stages, and hence dust leaks toward devices such as the gas turbine provided at the downstream side can be reliably prevented. Accordingly, since the adverse effects of dust leaks on the gas turbine provided at the downstream side can be prevented, continuous operation of the IGCC plant can be performed, and as a result, the reliability of power generation can be significantly improved.

In addition, when the dust removing system is formed to have a plurality of lines disposed in parallel to form a multiple-line configuration, and the equalizer pipe is provided to connect between the lines of the dust removing system at the inlets of the filters, the occurrence of imbalances in gas flow rates between the lines can be prevented, and as a result, the dust removing performance in each line can be satisfactorily obtained.

In addition, when the filters provided at multiple stages are the same, that is, when the capacity of each filter is set to be not less than 100% of a capacity required for each line, even though one filter provided at one stage has a problem and cannot be used, an IGCC plant having sufficient dust removing capacity can be continuously operated. Accordingly, since the adverse effects of the dust leak on the gas turbine located downstream can be prevented, the IGCC plant can be operated continuously, and as a result, the reliability of power generation can be significantly improved.

In addition, when the char recovered by the dust removing system is resupplied to the gasification furnace, the operation efficiency of the plant is improved because of the increase in the amount of the coal gas obtained from coal.

That is, according to the present invention described above, an integrated coal gasification combined cycle plant having a highly reliable dust removing system can be provided. The dust removing system described above can satisfy requirements for recent IGCC plants aiming to realize larger capacity, can have sufficient desired dust removing performance even when the gas volume is increased concomitant with the increase in capacity, and can maintain operational reliability because the occurrence of dust leaks is prevented.

### BRIEF DESCRIPTION OF THE SEVERAL VIEWS OF THE DRAWINGS

FIG. 1 is a schematic diagram showing one embodiment of an integrated coal gasification combined cycle (IGCC) plant according to the present invention.

### DETAILED DESCRIPTION OF THE INVENTION

Hereinafter, an integrated coal gasification combined cycle (hereinafter referred to as “IGCC”) plant according to the present invention will be described with reference to the drawing.

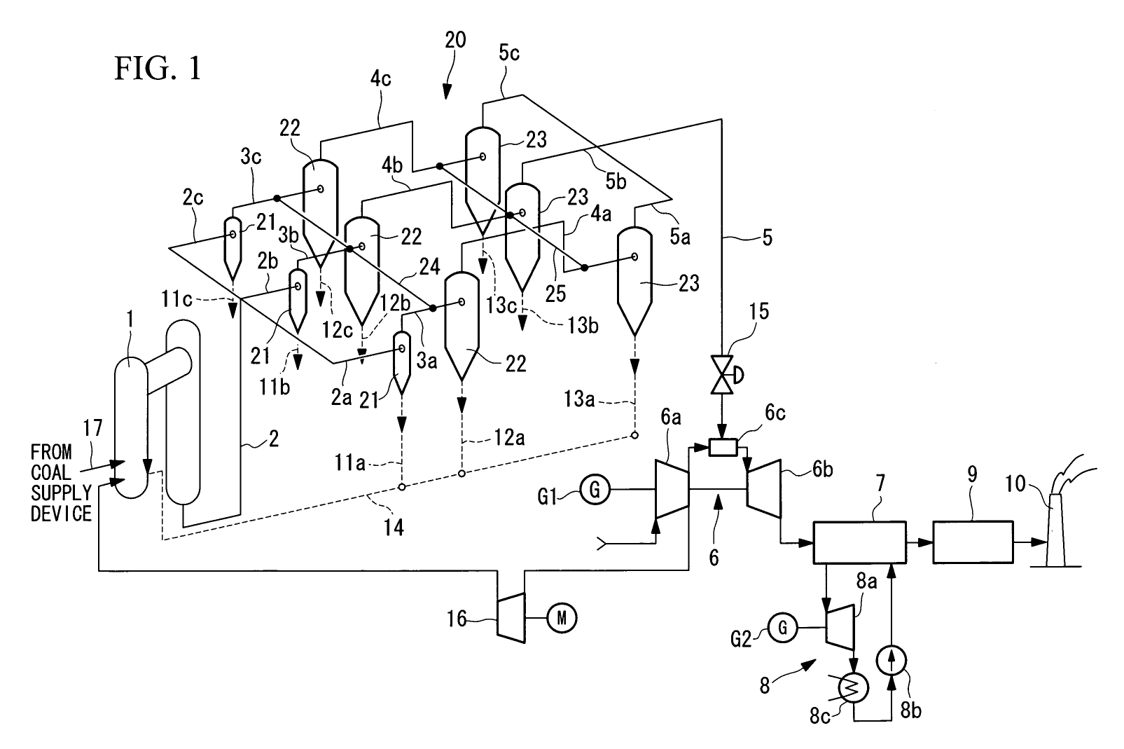

The IGCC plant shown in FIG. 1 has a coal gasification furnace 1 configured to yield a coal gas by gasification of coal, a gas turbine generator 6 driven with a gas turbine 6b operated using the coal gas as fuel, an exhaust heat recovery boiler 7 configured to recover heat from a high-temperature combustion exhaust gas discharged from the gas turbine 6b and to produce steam, and a steam turbine generator 8 driven with a steam turbine 8a operated using the steam produced by the exhaust heat recovery boiler 7.

As a gas purification device configured to desulfurize a coal gas, a flue gas desulfurization device 9 is provided downstream of the exhaust heat recovery boiler 7. This flue gas desulfurization device 9 has a desulfurization function of removing a sulfur oxide and the like contained in an combustion exhaust gas generated by combustion of a coal gas containing a sulfur component, and a combustion exhaust gas treated by environmental measures such as a desulfurization treatment is emitted into the atmosphere from a chimney 10. As a particular example of a usable flue gas desulfurization device 9, for example, a limestone/gypsum desulfurization device which absorbs SOx or an ACF desulfurization device which uses activated-carbon fibers may be mentioned.

In the gas turbine generator 6, an air compressor 6a, the gas turbine 6b, and a power generator G1 are connected to the same shaft and are configured to be integrally rotated. The gas turbine 6b is rotated by a combustion gas supplied from a combustor 6c and functions as a driving source for the air compressor 6a and the power generator G1 connected to the same shaft. In addition, the combustor 6c combusts a coal gas with compressed air supplied from the air compressor 6a to produce a high-temperature and high-pressure combustion gas.

The exhaust heat recovery boiler 7 is configured to recover exhaust heat of a combustion gas discharged after working for the gas turbine 6b, that is, a combustion exhaust gas, so as to produce steam. The steam produced by this exhaust heat recovery boiler 7 is supplied to the steam turbine generator 8.

In the steam turbine generator 8, the steam turbine 8a and a power generator G2 are connected to the same shaft and are configured to be integrally rotated. The steam turbine 8a is rotated by the steam supplied from the exhaust heat recovery boiler 7 and functions as a driving source for the power generator G2 connected to the same shaft. In addition, reference numerals 8b and 8c in the figure indicate a water-supply pump and a steam condenser, respectively.

A dust removing system 20 configured to recover char from a coal gas and also to remove dust and the like therefrom is provided for a coal-gas supply pipe 2 connecting the coal gasification furnace 1 and the gas turbine generator 6. In the dust removing system 20 used in this embodiment, a cyclone 21, a front-stage filter 22 and a rear-stage filter 23 are connected in series to form one dust removing system line. In the example shown in the figure, two-stage filtration is shown in which the front-stage filter 22 and the rear-stage filter 23 are connected in series; however, the number of the stages for the filtration is not particularly limited as long as it is at least two.

In addition, as the front-stage filter 22 and the rear-stage filter 23, the same filter having the same desired processing capacity (same properties) is preferably selected.

Furthermore, in the above dust removing system 20, three lines are disposed in parallel to form a multiple-line configuration, and in addition, equalizer pipes 24 and 25 are provided at the inlets of the front-stage filters 22 and the inlets of the rear-stage filters 23, respectively, so that the lines of the dust removing system are connected to each other. In addition, in the example shown in the figure, the three dust removing system lines are disposed in parallel; however, the number of the lines is not particularly limited as long as at least two lines are provided.

The cyclone 21, the front-stage filter 22, and the rear-stage filter 23 each have an inlet (gas inlet) for a coal gas, an outlet (gas outlet) for a coal gas, and an outlet (char outlet) for char.

Gas inlet pipes 2a, 2b, and 2c which are branched from the coal-gas supply pipe 2 are connected to the gas inlets of the respective cyclones 21 disposed to form the three lines. In addition, gas outlet pipes 3a, 3b, and 3c are connected to the gas outlets provided at the upper portions of the respective cyclones 21, and char recovery pipes 11a, 11b, and 11c are connected to the char outlets provided at the lower portions of the respective cyclones 21.

The other ends of the gas outlet pipes 3a, 3b, and 3c are connected to the gas inlets of the respective front-stage filters 22. In addition, the three gas outlet pipes 3a, 3b, and 3c are connected to each other by the equalizer pipe 24 so that gases of the above gas outlet pipes may be communicated therebetween. Gas outlet pipes 4a, 4b, and 4c are connected to the gas outlets provided at the upper portions of the respective front-stage filters 22, and char recovery pipes 12a, 12b, and 12c are connected to the char outlets provided at the lower portions of the respective front-stage filters 22.

The other ends of the gas outlet pipes 4a, 4b, and 4c are connected to the gas inlets of the respective rear-stage filters 23. In addition, the three gas outlet pipes 4a, 4b, and 4c are connected to each other by the equalizer pipe 25 so that gases of the above gas outlet pipes may be communicated therebetween. Gas outlet pipes 5a, 5b, and 5c are connected to the gas outlets provided at the upper portions of the respective rear-stage filters 23, and char recovery pipes 13a, 13b, and 13c are connected to the char outlets provided at the lower portions of the respective rear-stage filters 23.

In addition, the above char recovery pipes 11a to 11c, 12a to 12c, and 13a to 13c are all connected to a char supply pipe 14, so that recovered char is collected and is then resupplied to the coal gasification furnace 1 by the char supply pipe 14.

The gas outlet pipes 5a, 5b, and 5c connected to the gas outlets of the rear-stage filters 23 are extended and connected to each other at a predetermined position to form one gas supply pipe 5 configured to supply a coal gas, and this gas supply pipe 5 is connected to the combustor 6c of the gas turbine generator 6 via a produced-gas-pressure reducing valve 15.

Reference numeral 16 in the figure indicates an air-pressure increasing device configured so that the pressure of compressed air partly introduced (extracted) from the air compressor 6a is increased to a desired value and so that the compressed air thus obtained is supplied to the coal gasification furnace 1; and reference numeral 17 in the figure indicates a raw material supply line configured to supply coal for use as a raw material to the coal gasification furnace 1 from a coal supply device (not shown).

The operation and the function of the IGCC plant having the structure described above will be described together with the flow of coal gas.

Coal used as a raw material for a coal gas is pulverized by a pulverizer (not shown) and is then supplied to the coal gasification furnace 1 via the raw material supply line 17 having a hopper and the like. The coal (fine powdered coal) supplied to the coal gasification furnace 1 is combusted together with oxygen added to combustion air which is extracted from the air compressor 6a and which is then processed by the air-pressure increasing device 16 to have an increased pressure, thereby performing gasification. In this step, char recovered in the char supply pipe 14 by the dust removing system 20 is also combusted in the coal gasification furnace 1 for gasification.

A coal gas produced in the coal gasification furnace 1 is introduced into the cyclones 21 via the gas supply pipe 2, and in this step, since the coal gas is made to flow separately through the three gas inlet pipes 2a, 2b, and 2c, the coal gas is distributed to the three cyclones 21. The coal gas flowing into the cyclones 21 is separated from char and dust by centrifugal force and is then supplied into the front-stage filters 22 from the gas outlets via the gas outlet pipes 3a, 3b, and 3c. In addition, the char separated from the coal gas in the cyclones 21 is recovered in the char supply pipe 14 via the char recovery pipes 11a, 11b, and 11c.

The coal gas introduced into the front-stage filters 22 is made to pass through the filters so that remaining char and dust which were not separated by the cyclones 21 are removed and is then introduced into the rear-stage filters 23 from the gas outlets via the gas outlet pipes 4a, 4b, and 4c. In addition, the char separated from the coal gas in the front-stage filters 22 is recovered in the char supply pipe 14 via the char recovery pipes 12a, 12b, and 12c.

The coal gas introduced into the rear-stage filters 23 is made to pass through the filters so that remaining char and dust which were not separated by the front-stage filters 22 are removed, is then introduced into the gas supply pipe 5 from the gas outlets via the gas outlet pipes 5a, 5b, and 5c, and is further introduced into the combustor 6c of the gas turbine generator 6 via the gas supply pipe 5 and the produced-gas-pressure reducing valve 15. In addition, the char separated from the coal gas in the rear-stage filters 23 is recovered in the char supply pipe 14 via the char recovery pipes 13a, 13b, and 13c.

The coal gas thus supplied to the combustor 6c is combusted with compressed air supplied from the air compressor 6a to produce a high-temperature and high-pressure combustion gas, and the gas thus produced is then supplied to the gas turbine 6b. The gas turbine 6b is rotated using energy of the combustion gas and functions as a driving source of the air compressor 6a and the power generator G1 connected to the same shaft, so that power generation is performed.

The combustion gas driving the gas turbine 6b is converted to a combustion exhaust gas having exhaust heat and is then introduced into the exhaust heat recovery boiler 7. The exhaust heat recovery boiler 7 recovers the exhaust heat from the combustion exhaust gas to produce steam. By this steam, the steam turbine 8a is rotated and functions as a driving force of the power generator G2 connected to the same shaft, so that power generation is performed.

The combustion exhaust gas which generates the steam in the exhaust heat recovery boiler 7 is made to pass through the flue gas desulfurization device 9 for desulfurization treatment to remove sulfur oxide and the like and is then emitted into the atmosphere from the chimney 10.

Accordingly, the coal gas supplied to the gas turbine 6b may not pass through the gas purification device, and the pressure loss generated when the coal gas passes through the gas purification device can be prevented. Accordingly, since the pressure of the coal gasification furnace 1 can be decreased, in other words, since the pressure at the outlet of the coal gasification furnace 1, which is required to supply the coal gas to the combustor 6c, can be set to be low, the power supplied, for example, to the air-pressure increasing device 16 and the oxygen/nitrogen compressor, both of which supply gases to the gasification furnace 1, can be decreased, and as a result, the plant efficiency can be significantly improved.

In addition, by the use of the dust removing system 20 having the cyclones 21, the front-stage filters 22, and the rear-stage filters 23, after char, dust, and the like having a relatively large particle diameter are recovered and removed by the cyclones 21, since the coal gas is made to further pass through the filters provided at the two stages, recovery of remaining char and removal of small particles of dust and the like can be sequentially performed, and as a result, dust leaks toward the devices, such as the gas turbine 6b, located at the downstream side, can be reliably prevented. Accordingly, since the combustor 6c and the gas turbine 6b disposed at the downstream side can be prevented by the dust removing system 20 from being adversely affected by dust leaks, the frequency of suspension of operation of the IGCC plant can be decreased, and the continuous operation time can be increased; hence, as a result, the reliability of power generation can be improved. The improvement in reliability of power generation as described above is very important, in particular, for an IGCC plant having a larger capacity.

In addition, when the three lines of the dust removing system 20 are disposed in parallel to form a multiple-line configuration, and when the equalizer pipes 24 and 25 are provided to connect between the lines of the dust removing system 20 at the inlet sides of the front-stage filters 22 and at the inlet sides of the rear-stage filters 23, respectively, the occurrence of imbalances in gas flow rates between the individual lines can be prevented. That is, even when the imbalances in the power loss between the individual lines occur, since the lines are connected to each other with the equalizer pipes 24 and 25, the above imbalances can be overcome, and the dust collection performances of the filters can be made to be equivalent to each other, so that the dust removing performance of each line can be sufficiently utilized. In addition, a method may be conceived in which the supply pipes of the coal gas are formed into one supply pipe at the outlet of the cyclones 21 and in which this one supply pipe is then again separated into pipes for the respective lines. However, the size of a blocking valve (not shown) or the like necessary for the supply pipe is increased, and the installation space is increased thereby; hence, the method described above is not suitable for a plant having a large capacity.

In addition, when the front-stage filter 22 and the rear-stage filter 23, which are connected in series, have the same capacity, that is, when the capacities of the filters 22 and 23 are each set to be not less than 100% of a capacity required for each line, even when one filter (provided at one of the stages) of the above two has a problem and cannot be used, the IGCC plant can be continuously operated while the dust removing capacity necessary for each line is ensured. Accordingly, since the gas turbine 6b disposed at the downstream side can be prevented from being adversely affected by dust leaks, continuous operation can be performed, and as a result, the reliability of power generation can be significantly improved.

In addition, when the char recovered by the dust removing system 20 is resupplied to the gasification furnace 1, since the amount of coal gas obtained from coal can be increased, the operation efficiency of the IGCC plant can be improved.

As has thus been described, the above IGCC plant according to the present invention has a dust removing system 20 which can meet the requirements for recent IGCC plants aiming to realize larger capacity, and hence an integrated coal gasification combined cycle plant can be provided having the dust removing system 20 which reliably exhibits desired dust removing performance even when the volume of a coal gas is increased concomitant with the increase in capacity and which has superior operation reliability such that the occurrence of dust leaks is prevented.

Furthermore, since the present invention is not limited to the above embodiments, modifications and changes may be made without departing from the spirit and the scope of the present invention, and for example, a single-shaft combined system in which the steam turbine 8a is connected to the shaft of the gas turbine generator 6 may also be used.

What is claimed is:

1. An integrated coal gasification combined cycle plant comprising:
a coal gasification furnace configured to yield a coal gas by gasification of coal;
a gas turbine generator driven with a gas turbine which is operated using the coal gas as fuel and which discharges a high-temperature combustion exhaust gas;
an exhaust heat recovery boiler configured to recover heat from the high-temperature combustion exhaust gas and to produce steam;
a steam turbine generator driven with a steam turbine which is operated using the steam produced by the exhaust heat recovery boiler;
a gas purification device configured to desulfurize the coal gas, which is provided downstream of the gas turbine and the exhaust heat recovery boiler; and
a dust removing system configured to recover char and remove dust from the coal gas, which includes at least one line containing a cyclone and filters provided at multiple stages.

2. The integrated coal gasification combined cycle plant according to claim 1, wherein the dust removing system includes a plurality of lines disposed in parallel to form a multiple-line configuration and further includes at least one equalizer pipe configured to connect between the lines at inlets of the filters.

3. The integrated coal gasification combined cycle plant according to claim 1, wherein the filters provided at multiple stages are the same.

4. The integrated coal gasification combined cycle plant according to claim 1, wherein the char recovered by the dust removing system is resupplied to the gasification furnace.

5. The integrated coal gasification combined cycle plant according to claim 1, wherein the gas purification device is a limestone/gypsum desulfurization device in which SOx is absorbed or an ACF desulfurization device using activated-carbon fibers.
